(19) United States
(12) Patent Application Publication
(10) Pub. No.: US 2026/0280820 A1
(43) Pub. Date: Sep. 17, 2026

(54) ML MODEL GENERALIZATION AND SPECIFICATION

(71) Applicant: QUALCOMM Incorporated, San Diego, CA (US)

(72) Inventors: Srinivas YERRAMALLI, San Diego, CA (US); Taesang YOO, San Diego, CA (US); Chenxi HAO, Beijing (CN); Hamed PEZESHKI, San Diego, CA (US); Jay Kumar SUNDARARAJAN, San Diego, CA (US); Mohammed Ali Mohammed HIRZALLAH, San Marcos, CA (US)

(21) Appl. No.: 18/877,127

(22) PCT Filed: Aug. 24, 2023
(86) PCT No.: PCT/CN2023/114592

§ 371 Date: Dec. 19, 2024

(30) Foreign Application Priority Data
Aug. 26, 2022 (WO) PCT/CN2022/115317

(51) Int. Cl. H04L 5/00; H04L 41/16

(52) U.S. Cl. CPC H04L 5/0058; H04L 5/0053; H04L 41/16

(57) ABSTRACT

Certain aspects of the present disclosure provide techniques for determining applicability of machine learning (ML) models to a cell in wireless communications networks. An example method for wireless communications, performed at a User Equipment (UE) includes storing, for a first machine learning (ML) model, at least a first type of generalization characteristics supported by the first ML model; and determining applicability of the first ML model for a cell, based on the first type of generalization characteristics supported by the first ML model and deployment characteristics for the cell indicated by a network entity of the cell.

### CROSS-REFERENCE TO RELATED APPLICATIONS

This application claims priority to International Application No. PCT/CN2022/115317, filed Aug. 26, 2022, which is assigned to the assignee hereof and hereby expressly incorporated by reference in its entirety as if fully set forth below and for all applicable purposes.

### BACKGROUND

### Field of the Disclosure

Aspects of the present disclosure relate to wireless communications, and more particularly, to techniques for determining applicability of machine learning (ML) models to a cell in wireless communications networks.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

One aspect provides a method of wireless communications by a user equipment (UE). The method includes storing at least a first type of generalization characteristics supported by a first machine learning (ML) model and determining applicability of the first ML model to a cell, based on the first type of generalization characteristics supported by the first ML model and deployment characteristics of the cell.

Another aspect provides a method of wireless communications by a network entity. The method includes determining deployment characteristics of a cell served by the network entity and receiving an indication that at least a first machine learning (ML) model, deployed at a user equipment (UE), is applicable to the cell, based on at least a first type of generalization characteristics supported by the first ML model and the deployment characteristics.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates example beam refinement procedures, in accordance with certain aspects of the present disclosure.

FIG. 6 is a diagram illustrating example operations where beam management may be performed.

FIG. 7 illustrates a general functional framework applied for AI-enabled RAN intelligence.

FIG. 8 illustrates an example call flow diagram in accordance with aspects of the present disclosure.

FIG. 9 depicts a method for wireless communication.

FIG. 10 depicts a method for wireless communication.

FIG. 11 depicts a communications device that may include various components configured to perform operations for the techniques disclosed herein in accordance with aspects of the present disclosure.

### DETAILED DESCRIPTION

Aspects of the present disclosure provide apparatuses, methods, processing systems, and computer-readable mediums for categorizing machine learning (ML) models used in wireless communications networks.

Performance monitoring and reporting feedback (e.g., based on the performance monitoring) are important for proper operations of artificial intelligence (AI) and machine learning (ML) based algorithms (simply referred to as an ML model herein) deployed in wireless communications networks. The feedback may include values for commonly used parameters, referred to as key performance indicators (KPIs). The feedback may also include use-case specific parameters that need to be monitored, evaluated, and reported time-to-time for appropriate actions.

Certain ML models may be suitable or applicable to certain cell deployment scenarios. For example, certain ML models may be categorized as being applicable across one or more cell deployment scenarios that have common generalization characteristics. Aspects of the present disclosure provide various aspects of ML model generalization indication with respect to such categorization, which may improve usability and efficacy of ML models in a greater number cell deployment scenarios.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

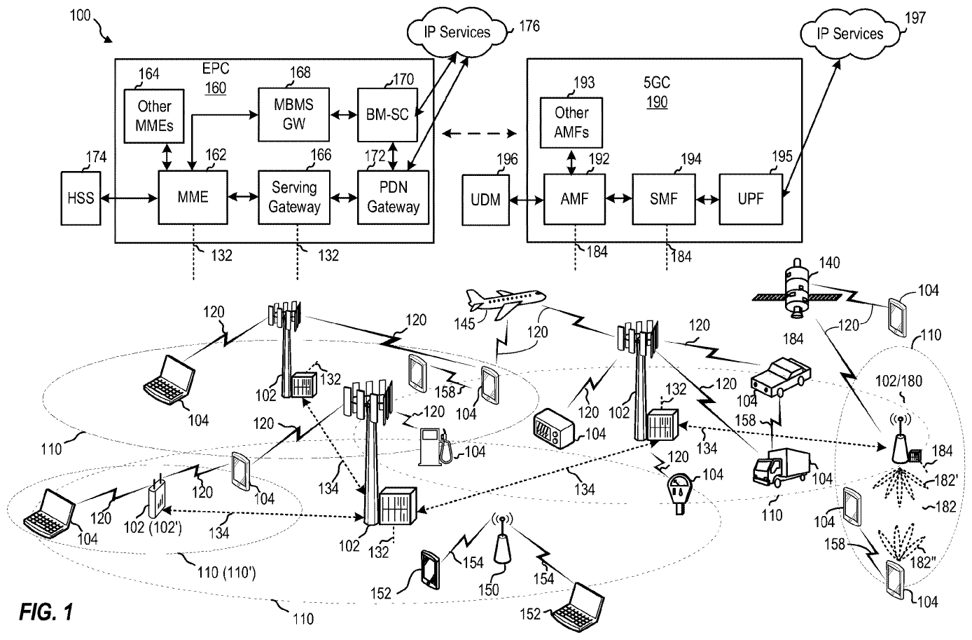

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

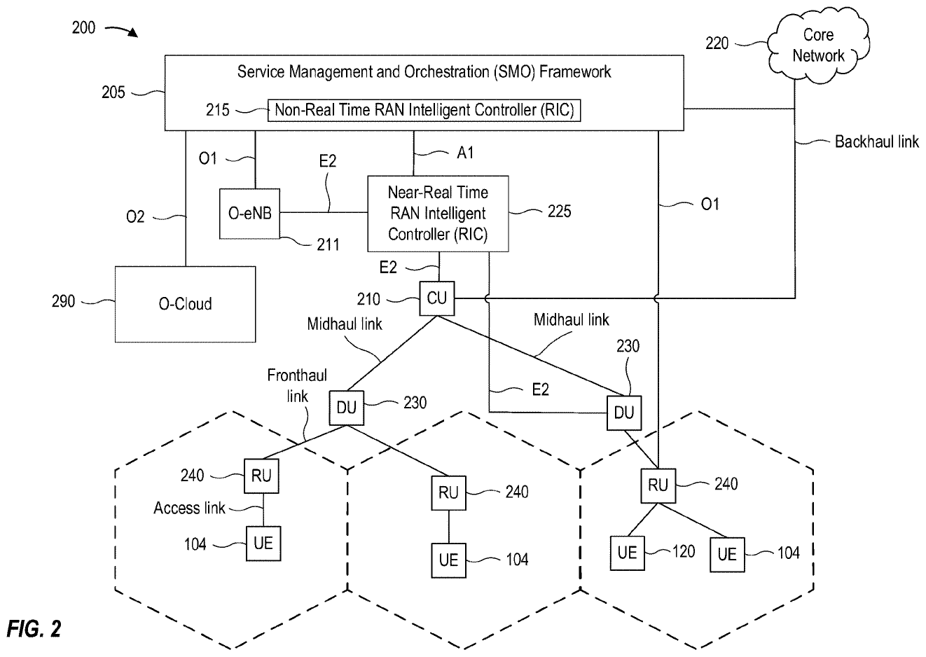

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mm Wave”). A base station configured to communicate using mmWave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

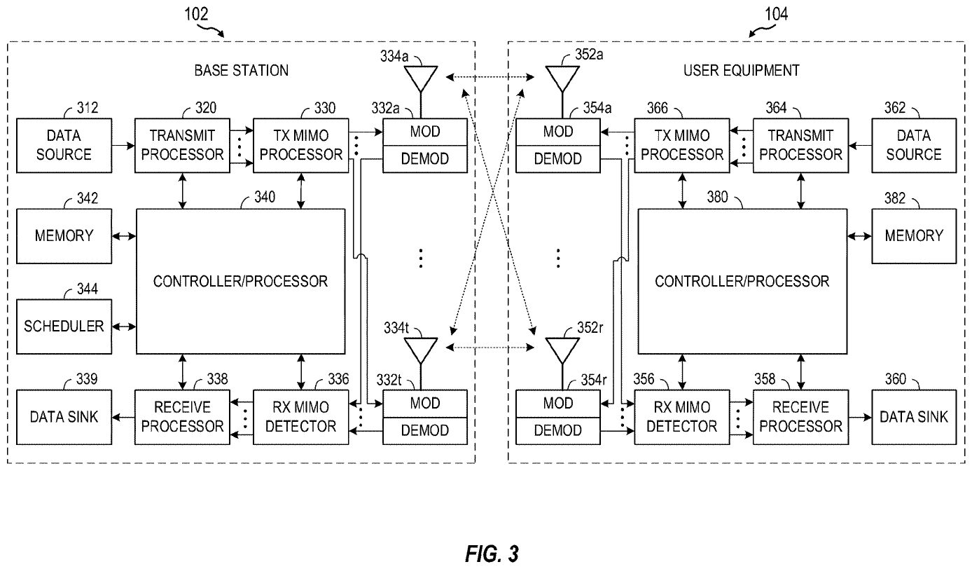

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by an RX MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-r, antenna 352a-r, and/or other aspects described herein. Similarly, “receiving” may refer to various mechanisms of obtaining data, such as obtaining data from antennas 352a-r, transceivers 354a-r, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

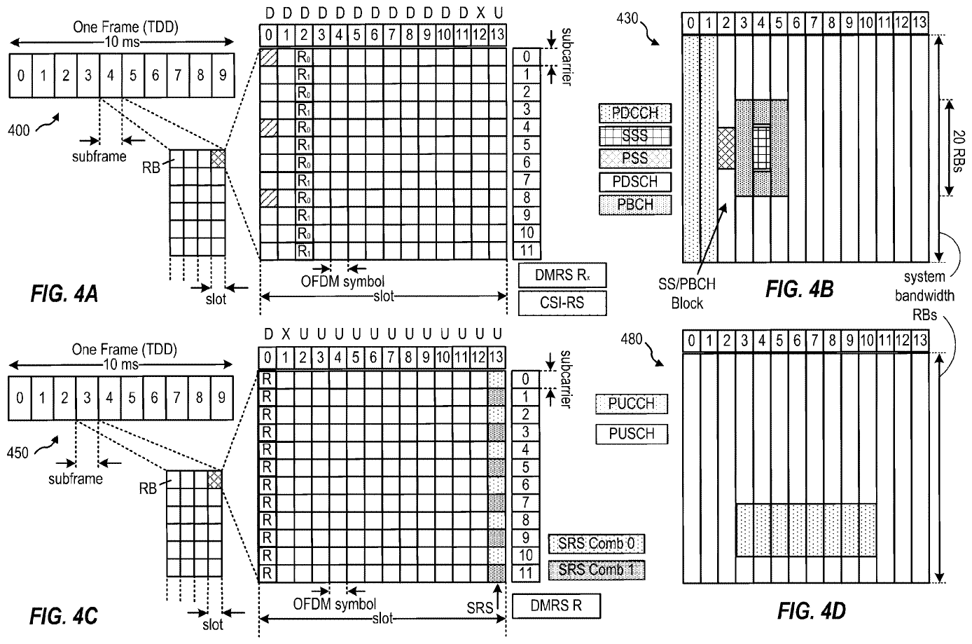

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Beam Refinement Procedures

In mm Wave systems, beam forming may be important to overcome high path-losses. As described herein, beamforming may refer to establishing a link between a BS and a UE, wherein both of the devices form a beam corresponding to each other. Both the BS and the UE find at least one adequate beam to form a communication link. BS-beam and UE-beam form what is known as a beam pair link (BPL). As an example, on the DL, a BS may use a transmit beam and a UE may use a receive beam corresponding to the transmit beam to receive the transmission. The combination of a transmit beam and corresponding receive beam may be a BPL.

As a part of beam management, beams which are used by BS and UE have to be refined from time to time because of changing channel conditions, for example, due to movement of the UE or other objects. Additionally, the performance of a BPL may be subject to fading due to Doppler spread. Because of changing channel conditions over time, the BPL should be periodically updated or refined. Accordingly, it may be beneficial if the BS and the UE monitor beams and new BPLs.

At least one BPL has to be established for network access. As described above, new BPLs may need to be discovered later for different purposes. The network may decide to use different BPLs for different channels, or for communicating with different BSs (e.g., transmission reception points (TRPs)) or as fallback BPLs in case an existing BPL fails.

The UE typically monitors the quality of a BPL and the network may refine a BPL from time to time.

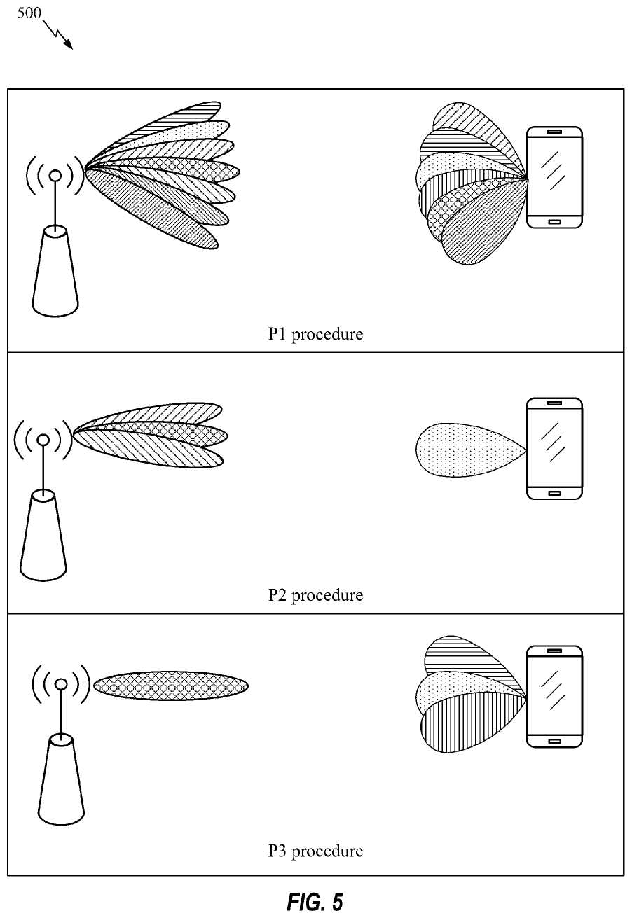

FIG. 5 illustrates example 500 for BPL discovery and refinement. In 5G-NR, the P1, P2, and P3 procedures are used for BPL discovery and refinement. The network uses a P1 procedure to enable the discovery of new BPLs. In the P1 procedure, as illustrated in FIG. 5, the BS transmits different symbols of a reference signal, each beam formed in a different spatial direction such that several (e.g., most or all) relevant places of the cell are reached. Stated otherwise, the BS transmits beams using different transmit beams over time in different directions.

For successful reception of at least a symbol of this “P1-signal”, the UE has to find an appropriate receive beam. It searches using available receive beams and applying a different UE-beam during each occurrence of the periodic P1-signal.

Once the UE has succeeded in receiving a symbol of the P1-signal it has discovered a BPL. The UE may not want to wait until it has found the best UE receive beam, since this may delay further actions. The UE may measure the reference signal receive power (RSRP) and report the symbol index together with the RSRP to the BS. Such a report will typically contain the findings of one or more BPLs.

In an example, the UE may determine a received signal having a high RSRP. The UE may not know which beam the BS used to transmit; however, the UE may report to the BS the time at which it observed the signal having a high RSRP. The BS may receive this report and may determine which BS beam the BS used at the given time.

The BS may then offer P2 and P3 procedures to refine an individual BPL. The P2 procedure refines the BS-beam of a BPL. For example, the BS may transmit a few symbols of a reference signal with different BS-beams that are spatially close to the BS-beam of the BPL (the BS performs a sweep using neighboring beams around the selected beam). In P2, the UE keeps its beam constant. Thus, while the UE uses the same beam as in the BPL (as illustrated in P2 procedure in FIG. 5), the BS-beams used for P2 may be different from those for P1 in that they may be spaced closer together or they may be more focused. The UE may measure the RSRP for the various BS-beams and indicate the best one to the BS.

The P3 procedure refines the UE-beam of a BPL (see P3 procedure in FIG. 5). While the BS-beam stays constant, the UE scans using different receive beams (the UE performs a sweep using neighboring beams). The UE may measure the RSRP of each beam and identify the best UE-beam. Afterwards, the UE may use the best UE-beam for the BPL and report the RSRP to the BS.

Over time, the BS and UE establish several BPLs. When the BS transmits a certain channel or signal, it lets the UE know which BPL will be involved, such that the UE may tune in the direction of the correct UE receive beam before the signal starts. In this manner, every sample of that signal or channel may be received by the UE using the correct receive beam. In an example, the BS may indicate for a scheduled signal (e.g., SRS, CSI-RS) or channel (e.g., PDSCH, PDCCH, PUSCH, PUCCH) which BPL is involved. In NR, this information may be referred to as a quasi co-location (QCL) indication.

Two antenna ports are quasi co-located (QCL) if properties of the channel over which a symbol on one antenna port is conveyed may be inferred from the channel over which a symbol on the other antenna port is conveyed. QCL supports, at least, beam management functionality, frequency/timing offset estimation functionality, and radio resource management (RRM) functionality.

The BS may use a BPL which the UE has received, established, and/or used in the past. The transmit beam for the signal to be transmitted and the previously-received signal both point in a same direction and/or are QCL. The QCL indication may be needed by the UE (in advance of signal to be received) such that the UE may use a correct receive beam for each signal or channel. Some QCL indications may be needed from time to time when the BPL for a signal or channel changes and some QCL indications are needed for each scheduled instance. The QCL indication may be transmitted in the downlink control information (DCI), which may be part of the PDCCH channel. Because DCI is needed to control the information, it may be desirable that the number of bits needed to indicate the QCL is not too big. The QCL may be transmitted in a medium access control-control element (MAC-CE) or radio resource control (RRC) message.

According to one example, whenever the UE reports a BS beam that it has received with sufficient RSRP, and the BS decides to use this BPL in the future, the BS assigns it a BPL tag. Accordingly, two BPLs having different BS beams may be associated with different BPL tags. BPLs that are based on the same BS beams may be associated with the same BPL tag. Thus, according to this example, the tag is a function of the BS beam of the BPL.

As noted above, wireless systems, such as millimeter wave (mmW) systems, bring gigabit speeds to cellular networks, due to availability of large amounts of bandwidth. However, the unique challenges of heavy path-loss faced by such wireless systems necessitate new techniques such as hybrid beamforming (analog and digital), which are not present in 3G and 4G systems. Hybrid beamforming may enhance link budget/signal to noise ratio (SNR) that may be exploited during the RACH.

In such systems, a node B (NB) and a user equipment (UE) may communicate over active beam-formed transmission beams. Active beams may be considered paired transmission (Tx) and reception (Rx) beams between the NB and UE that carry data and control channels such as PDSCH, PDCCH, PUSCH, and PUCCH. As noted above, a transmit beam used by a NB and corresponding receive beam used by a UE for downlink transmissions may be referred to as a beam pair link (BPL). Similarly, a transmit beam used by a UE and corresponding receive beam used by a NB for uplink transmissions may also be referred to as a BPL.

Since the direction of a reference signal is unknown to the UE, the UE may evaluate several beams to obtain the best Rx beam for a given NB Tx beam. However, if the UE has to “sweep” through all of its Rx beams to perform the measurements (e.g., to determine the best Rx beam for a given NB Tx beam), the UE may incur significant delay in measurement and battery life impact. Moreover, having to sweep through all Rx beams is highly resource inefficient. Thus, aspects of the present disclosure provide techniques to assist a UE when performing measurements of serving cells and neighbor cells when using Rx beamforming.

### Example Beam Management

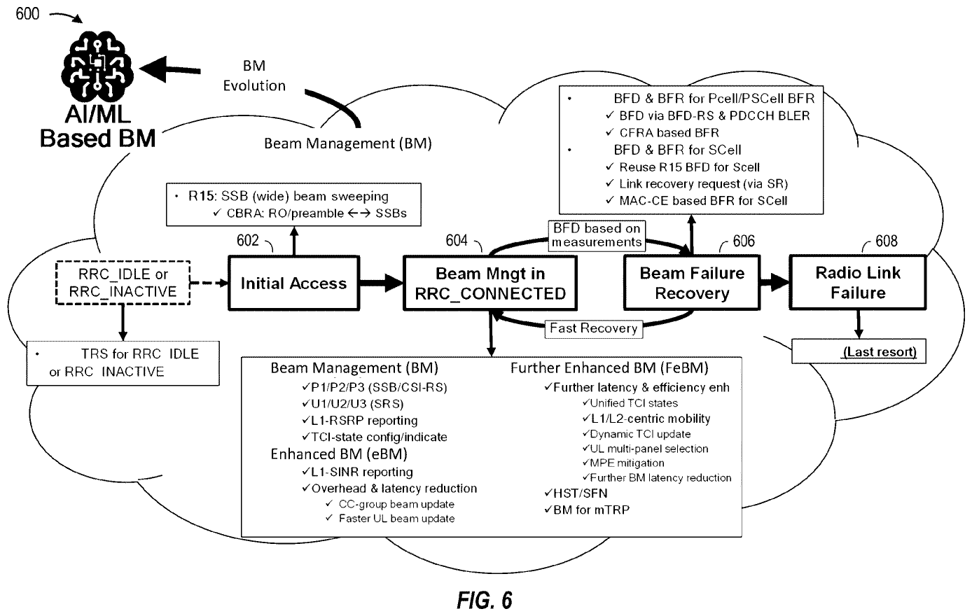

In wireless communications, various procedures may be performed for beam management. FIG. 6 is a diagram 600 illustrating example operations where beam management may be performed. In initial access 602, the network may sweep through several beams, for example, via synchronization signal blocks (SSBs), as further described herein with respect to FIG. 4B. The network may configure the UE with random access channel (RACH) resources associated with the beamformed SSBs to facilitate the initial access via the RACH resources. In certain aspects, an SSB may have a wider beam shape compared to other reference signals, such as a channel state information reference signal (CSI-RS). A UE may use SSB detection to identify a RACH occasion (RO) for sending a RACH preamble (e.g., as part of a contention-based Random Access (CBRA) procedure).

In connected mode 604, the network and UE may perform hierarchical beam refinement including beam selection (e.g., a process referred to as P1), beam refinement for the transmitter (e.g., a process referred to as P2), and beam refinement for the receiver (e.g., a process referred to as P3). In beam selection (P1), the network may sweep through beams, and the UE may report the beam with the best channel properties, for example. In beam refinement for the transmitter (P2), the network may sweep through narrower beams, and the UE may report the beam with the best channel properties among the narrow beams. In beam refinement for the receiver (P3), the network may transmit using the same beam repeatedly, and the UE may refine spatial reception parameters (e.g., a spatial filter) for receiving signals from the network via the beam. In certain aspects, the network and UE may perform complementary procedures (e.g., U1, U2, and U3) for uplink beam management.

In certain cases where a beam failure occurs (e.g., due to beam misalignment and/or blockage), the UE may perform a beam failure recovery (BFR) procedure 606, which may allow a UE to return to connected mode 604 without performing a radio link failure procedure 608. For example, the UE may be configured with candidate beams for beam failure recovery. In response to detecting a beam failure, the UE may request the network to perform beam failure recovery via one of the candidate beams (e.g., one of the candidate beams with a reference signal received power (RSRP) above a certain threshold). In certain cases where radio link failure (RLF) occurs, the UE may perform an RLF procedure 608 (e.g., a RACH procedure) to recover from the radio link failure.

### Example Framework for AI/ML in a Radio Access Network

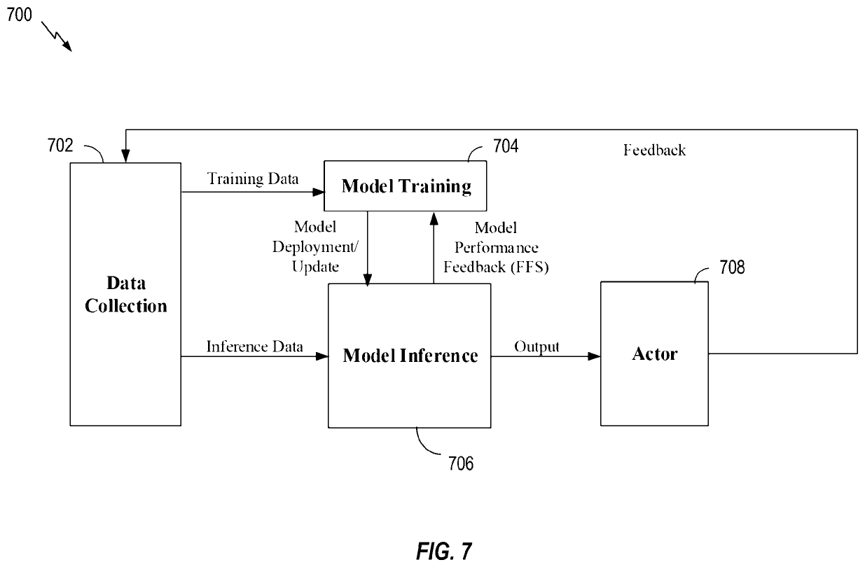

FIG. 7 depicts an example of AI/ML functional framework 700 for RAN intelligence, in which aspects described herein may be implemented.

The AI/ML functional framework includes a data collection function 702, a model training function 704, a model inference function 706, and an actor function 708, which interoperate to provide a platform for collaboratively applying AI/ML to various procedures in RAN.

The data collection function 702 generally provides input data to the model training function 704 and the model inference function 706. AI/ML algorithm specific data preparation (e.g., data pre-processing and cleaning, formatting, and transformation) may not be carried out in the data collection function 702.

Examples of input data to the data collection function 702 (or other functions) may include measurements from UEs or different network entities, feedback from the actor function, and output from an AI/ML model. In some cases, analysis of data needed at the model training function 704 and the model inference function 706 may be performed at the data collection function 702. As illustrated, the data collection function 702 may deliver training data to the model training function 704 and inference data to the model inference function 706.

The model training function 704 may perform AI/ML model training, validation, and testing, which may generate model performance metrics as part of the model testing procedure. The model training function 704 may also be responsible for data preparation (e.g., data pre-processing and cleaning, formatting, and transformation) based on the training data delivered by the data collection function 702, if required.

The model training function 704 may provide model deployment/update data to the model inference function 706. The model deployment/update data may be used to initially deploy a trained, validated, and tested AI/ML model to the model inference function 706 or to deliver an updated model to the model inference function 706.

As illustrated, the model inference function 706 may provide AI/ML model inference output (e.g., predictions or decisions) to the actor function 708 and may also provide model performance feedback to the model training function 704, at times. The model inference function 706 may also be responsible for data preparation (e.g., data pre-processing and cleaning, formatting, and transformation) based on inference data delivered by the data collection function 702, at times.

The inference output of the AI/ML model may be produced by the model inference function 706. Specific details of this output may be specific in terms of use cases. The model performance feedback may be used for monitoring the performance of the AI/ML model, at times. In some cases, the model performance feedback may be delivered to the model training function 704, for example, if certain information derived from the model inference function 706 is suitable for improvement of the AI/ML model trained in the model training function 704.

The model inference function 706 may signal the outputs of the model to nodes that have requested them (e.g., via subscription), or nodes that take actions based on the output from the model inference function 706. An AI/ML model used in a model inference function 706 may need to be initially trained, validated and tested by a model training function 704 before deployment. The model training function 704 and model inference function 706 may be able to request specific information to be used to train or execute the AI/ML algorithm and to avoid reception of unnecessary information. The nature of such information may depend on the use case and on the AI/ML algorithm.

The actor function 708 may receive the output from the model inference function 706, which may trigger or perform corresponding actions. The actor function 708 may trigger actions directed to other entities or to itself. The feedback generated by the actor function 708 may provide information used to derive training data, inference data or to monitor the performance of the AI/ML Model. As noted above, input data for a data collection function 702 may include this feedback from the actor function 708. The feedback from the actor function 708 or other network entities (e.g., via Data Collection function 702) may also be used at the model inference function 706.

The AI/ML functional framework 700 may be deployed in various RAN intelligence-based use cases. Such use cases may include CSI feedback enhancement, enhanced beam management (BM), positioning and location (Pos-Loc) accuracy enhancement, and various other use cases.

### Aspects Related to ML Model Generalization and Specification

Aspects of the present disclosure provide apparatuses, methods, processing systems, and computer-readable mediums for categorizing machine learning (ML) models used in wireless communications networks.

As used herein, generalization characteristics generally refer to characteristics or parameters which may be common among one or more cells or network configurations. Generalization characteristics, for example, may be categorized based on base station location information, cell range, propagation characteristics, antenna configurations, or one or more parameters. Certain generalization characteristics, like delay spread range, path loss range, UE speed range, multiple sectors in a cell, or an area map in a cell, may be applicable within a specific cell (e.g., indicated by global cell ID), a group of cells (e.g., indicated by a list of cell IDs, a RAN notification area ID, paging area ID, or a model cell group ID), and/or to all cells or a subset of cells (e.g., having a same network ID). As used herein, applicability of generalization characteristics may, for example, refer to compatibility, usability, relevance, or appropriateness of a generalization characteristic relative to a cell, a group of cells, a subset of cells, and/or a cell specific model (e.g., a model specific to a cell or subset of cells).

In some cases, applicability may be determined based on classes/groups/types of cells (e.g., dense urban type or indoor factory type) and/or deployment characteristics (e.g., similarity of deployment characteristics across different cells). Deployment characteristics may refer to a site/location of deployment, characteristics of a site of deployment (e.g., blockage conditions, traffic conditions, weather conditions, and/or other characteristics). For example, an ML model that is applicable to a cell deployment corresponding to a factory may not be applicable to a cell deployment corresponding to an urban area. Because the factory deployment may be represent a relatively controlled environment, inputs to the ML model may be optimized for relatively low variability (e.g., narrow ranges). On the other hand, the urban area may represent an environment that is difficult to control. As such, a different ML model with inputs that are optimized for higher variability (and larger ranges) may be more suitable for a cell deployment in an urban area.

As used herein, a machine learning (ML) model generally refers to a computational system that may learn from data and may make predictions or decisions. For example, an ML model may refer to a mathematical algorithm that is trained on a dataset to make predictions or decisions based on input data. ML models may be considered as a type of artificial intelligence (AI) that enables computers to learn and improve their performance over time without being explicitly programmed to do so. An ML model may learn from the data it is provided and identifies patterns or relationships within the data that can be used to make predictions about new data. ML models may be used for a wide range of applications, including image and speech recognition, natural language processing, and predictive analytics. There are several types of machine learning models, including supervised learning, unsupervised learning, and reinforcement learning.

Certain ML models may be suitable or applicable to certain cell deployment scenarios. For example, certain ML models may be categorized as being applicable across one or more cell deployment scenarios that have common generalization characteristics. Aspects of the present disclosure provide various aspects of ML model generalization indication with respect to such categorization.

Categorization of ML models may be beneficial for the development of new 5G systems, for example, to operate in a variety of bands (e.g., up to 100 GHz). Categorization may help achieve accurate radio propagation models. Channel models may include typical deployment scenarios for urban microcells (UMi) and urban macrocells (UMa). Certain (e.g., baseline) models may be used for incorporating path loss, shadow fading, line of sight probability, penetration and blockage models for the typical scenarios.

In some cases, certain generalization types may correspond to categories of ML models (as described above). The following generalization types may be considered (e.g., as having common generalized cell deployment characteristics).

A first type (Type 1) may correspond to a heterogeneous inter-site cell deployment (e.g., with UMi and Uma). For this first type, an AI/ML model may be expected to perform on a (previously) unseen deployment type (e.g., the model may be trained on a Dense Urban and tested on UMi).

A second type (Type 2) may correspond to a homogeneous inter-site cell deployment and an AI/ML model may be expected to perform on an unseen site of the same deployment type (e.g., trained on Dense Urban and tested on a new drop/location/scenario of a dense urban type). As an example, a model categorized by this type may be trained in a downtown of one city and deployed in a downtown of another city. On the other hand, a model that performs well for some downtown areas may not perform well in rural areas.

A third type (Type 3) may correspond to an Intra-site cell deployment, and an AI/ML model may be expected to perform on unseen variations within the same site (e.g., unseen UE locations, speeds, and trajectories within the drop, changes in moving objects in the environment).

A fourth type (Type 4) may correspond to cross-configuration, with performance of AI/ML models across the various configuration types described above (i.e., unseen beam configuration).

The categorization techniques proposed herein may generally be applied to any type of ML models, used for various purposes (e.g., for channel state feedback, beam prediction, or other purposes).

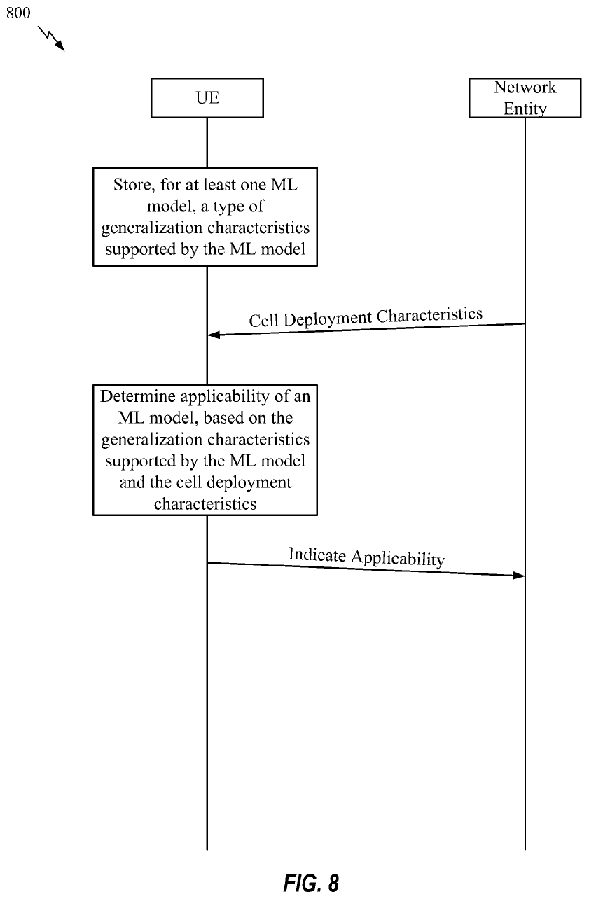

General concepts for categorizing ML models and determining applicability thereof may be understood with reference to the call flow diagram 800 of FIG. 8.

As illustrated, a UE may store, for one or more machine learning (ML) models, a type of generalization characteristics supported by each ML model. The network entity, in some cases, may configure the UE with the ML models.

In some cases, a network entity (e.g., gNB) may indicate (e.g., via broadcast signaling/SIB) deployment characteristics for a cell (e.g., a cell served by that network entity). The UE may determine the applicability of an ML model for the cell, based on the corresponding type of generalization characteristics supported by the ML model and the cell deployment characteristics.

In some cases, a network (or standard) may specify a standardized description of model generalization characteristics, for example, for the various types (Types 1-4) described above. While such categorization may be with respect to generating simulation data from channel models, a similar approach may be applicable to other (e.g., real world) models.

According to certain aspects, for each type for generalization, there may be several sub-types. Sub-types may provide the ability to indicate fine-grained capability if necessary (e.g., certain types of characteristics or values of certain parameters).

As an example, for the first type (Type 1: Heterogeneous inter-site) described above, there may be various sub-types. For example, these sub-types may include:
Rural Macro Type 1,2, . . . , N1, Urban Macro Type 1,2, . . . N2, Urban Micro Type 1,2, . . . , N3 . . .
   In some cases, the categories defining each sub-type may be defined (e.g., in a standard specification) based on characteristics, such as gNB location information, range of cell, propagation characteristics (e.g., delay spreads, angular spreads of the channel etc.), antenna configuration, or some combination of parameters determined by explicit indication from the network. For example, an urban macro and micro sub-types may be defined based on similar gNB location information (associated with an urban area), but different sizes of cell coverage (e.g., with an urban macro type associated with a larger coverage area than an urban micro type).

In some cases, a UE may indicate (e.g., to a network) that a given ML model may be applicable to any cell that belongs to a certain group or class (e.g., which may correspond to a generalization type in some cases), such as:
Rural Macro type 4, 5 (and Urban Marco type 1, 2, 3 etc.);
Indoor hotspot type 1 & Indoor factory type 2; or
Indoor factory type 2 & type 3.

Certain types (e.g., Type 2: Homogeneous inter-site) may apply to cell specific models or may be applicable to a group of cells with similar deployment characteristics. For example, within the category of UMi Type 2 cells, an ML model may be applicable to (only) a smaller sub-category of cells. According to a first option, such an ML model may be applicable to a specific cell indicated by global cell ID. According to a second option, an ML model may be applicable to a small group of cells indicated by a list of cell IDs or RAN notification area ID or paging area ID or newly defined ID for ML model cell groups. According to a third option, for private networks, an ML model may be applicable to all cells (or a subset of cells) with the same network ID.

There are also various possible sub-types for Type 3 categorization where an AI/ML model may be expected to perform on unseen variations within the same site (e.g., unseen UE locations, speeds, and trajectories within the drop, changes in moving objects in the environment). Such sub-types for Type 3 generalization characteristics may be applicable within a cell. Example of such cell generalization characteristics that are applicable within the cell may include at least one of: a delay spread range, a path loss range, a UE speed range, multiple sectors in a cell, or an area map in a cell.

For some types of categorization (e.g., Type 4: Cross-configuration) an AI/ML model may be expected to perform across configurations (e.g., with previously unseen beam configuration). Therefore, there are various sub-types for Type 4. For example, if a network indicates an RS configuration ID when a training data set is collected, a sub-type may be based on a range of RS configuration IDs supported by this model. Another subtype may indicate whether the model supports unseen RS configurations.

There are various options for signaling to indicate model generalization parameters. For example, an indication of model generalization parameters may be provided as the type (and sub-type) of generalization supported and may be stored together with the model and may be registered with the network along with the model. For example, a UE may register the model generalization supported by providing the network (e.g., via UE capability reporting) a description of the model generalization or model generalization parameters and associated ML models. This registration may aid the network in determining what ML models are supported by the UE. In some cases, the UE may provide generalization description (e.g., which may include generalization characteristics) to the network when UE uses a proprietary AI/ML model. In some cases, the network may indicate a generalization description to the UE (e.g., when the network configures an AI/ML model to the UE). Such generalization information may be indicated to the UE in broadcast signaling (e.g., through system information blocks (SIBs)) or through unicast signaling (e.g., via RRC, MAC-CE, DCI) or group (groupcast) signaling for a set of UEs (e.g., via RRC, MAC-CE, or DCI). In some cases, a UE may acknowledge the receipt of generalization information to the network (e.g., in a response to a message used to convey the generalization information).

In some cases, there may be multiple categories of generalization (e.g., generalization types) indicated for each model. For example, there may be a Type 2 indication for a group of cells, a Type 3 indication for specific parameters within the cell, and/or Type 4 RS Configurations (e.g., RS Configurations 1, 2, 3, . . . ).

In some cases, a UE may detect/determine an out-of-model-coverage-scenario. In such cases, the UE may report an out-of-model-coverage to the network, for example, when the input data is outside of the configured generalization description of the configured AI/ML model. There are various options for how a UE reports out of coverage or actions it performs upon detecting and reporting out of coverage.

For example, according to one option, the UE may request the network to deactivate the ML model (for network configured ML models). In some cases, a UE may request the network to (re)activate the ML model. According to a second option, the UE may request a model switch by indicating the current observed channel characteristics. According to a third option, the UE may continue to use the best matched model with reduced performance. According to a fourth option, the UE may switch on a data collection function for further optimization of the network.

### Example Operations of a User Equipment

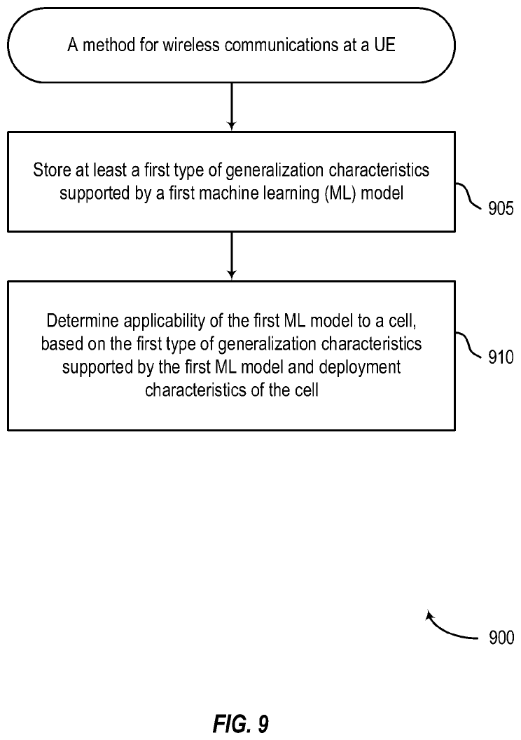

FIG. 9 shows an example of a method 900 for wireless communications by a UE, such as UE 104 of FIGS. 1 and 3.

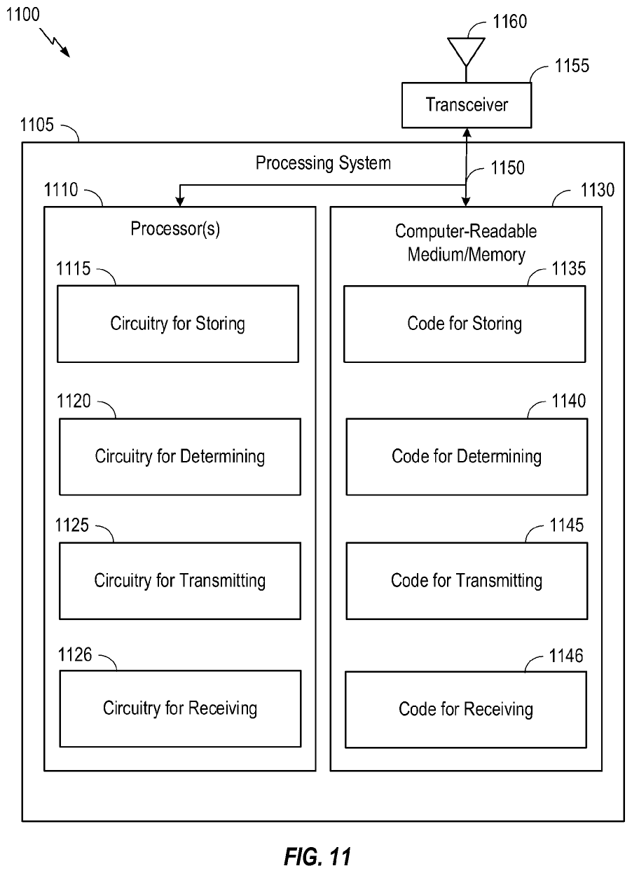

Method 900 begins at step 905 with storing at least a first type of generalization characteristics supported by a first machine learning (ML) model. In some cases, the operations of this step refer to, or may be performed by, circuitry for storing and/or code for storing as described with reference to FIG. 11.

Method 900 then proceeds to step 910 with determining applicability of the first ML model to a cell, based on the first type of generalization characteristics supported by the first ML model and deployment characteristics of the cell. In some cases, the operations of this step refer to, or may be performed by, circuitry for determining and/or code for determining as described with reference to FIG. 11.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Operations of a Network Entity

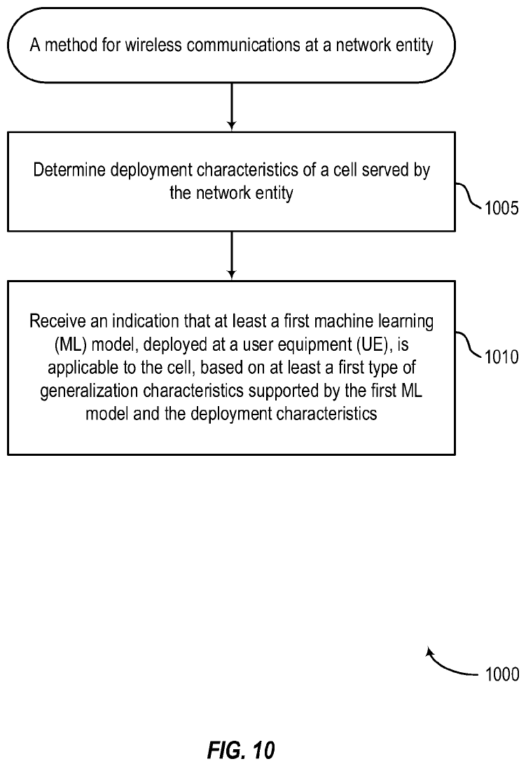

FIG. 10 shows an example of a method 1000 for wireless communications by a network entity, such as a base station 102 or component of a disaggregated base station, described above with respect to FIGS. 1, 2 and 3.

Method 1000 begins at step 1005 with determining deployment characteristics of a cell served by the network entity. Deployment characteristics may refer to a site/location of deployment, characteristics of a site of deployment (e.g., blockage conditions, traffic conditions, weather conditions, and/or other characteristics). For example, the determination may be based on a network configuration of a network provider and/or information (regarding deployment characteristics) obtained by the network entity (e.g., via a discovery process). In some cases, the network entity may transmit an indication of the deployment characteristics to a UE. In some cases, the operations of this step refer to, or may be performed by, circuitry for determining and/or code for determining as described with reference to FIG. 11.

Method 1000 then proceeds to step 1010 with receiving an indication that at least a first machine learning (ML) model, deployed at a UE, is applicable to the cell, based on at least a first type of generalization characteristics supported by the first ML model and the deployment characteristics. In some cases, the operations of this step refer to, or may be performed by, circuitry for receiving and/or code for receiving as described with reference to FIG. 11.

In one aspect, method 1000, or any aspect related to it, may be performed by an apparatus, such as communications device 1100 of FIG. 11, which includes various components operable, configured, or adapted to perform the method 1000. Communications device 1100 is described below in further detail.

Note that FIG. 10 is just one example of a method, and other methods including fewer, additional, or alternative steps are possible consistent with this disclosure.

### Example Wireless Communication Devices

FIG. 11 illustrates a communications device 1100 that may include various components (e.g., corresponding to means-plus-function components) configured to perform operations for the techniques disclosed herein, such as the operations illustrated in FIG. 9 and/or FIG. 10.

FIG. 11 depicts aspects of an example communications device 1100. In some aspects, communications device 1100 is a user equipment, such as UE 104, or a network entity, such as a base station 102 or component of a disaggregated base station, described above with respect to FIGS. 1, 2 and 3.

The communications device 1100 includes a processing system 1105 coupled to the transceiver 1155 (e.g., a transmitter and/or a receiver). The transceiver 1155 is configured to transmit and receive signals for the communications device 1100 via the antenna 1160, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code) that when executed by the one or more processors 1110, cause the one or more processors 1110 to perform the method 800 described with respect to FIG. 9 and/or FIG. 10, or any aspect related to it. Note that reference to a processor performing a function of communications device 1100 may include one or more processors 1110 performing that function of communications device 1100.

In the depicted example, computer-readable medium/memory 1130 stores code (e.g., executable instructions), such as code for storing 1135, code for determining 1140, code for transmitting 1145, and code for receiving 1146. Processing of the code may cause the communications device 1100 to perform the operations described with respect to FIG. 9 and/or FIG. 10, or any aspect related to it.

The one or more processors 1110 include circuitry configured to implement (e.g., execute) the code stored in the computer-readable medium/memory 1130, including circuitry such as circuitry for storing 1115, circuitry for determining 1120, circuitry for transmitting 1125, and circuitry for receiving 1126, which may be configured to cause the communications device 1100 to perform the operations described with respect to FIG. 9 and/or FIG. 10, or any aspect related to it.

Various components of the communications device 1100 may provide means for performing the method 800 described with respect to FIG. 9 and/or FIG. 10, or any aspect related to it. For example, means for storing, determining, transmitting, and/or receiving may include transceivers 354 and/or antenna(s) 352 of the UE 104 illustrated in FIG. 3. Means for receiving or obtaining may include transceivers 354 and/or antenna(s) 352 of the UE 104 illustrated in FIG. 3.

In some cases, the operations illustrated in FIG. 9 and/or FIG. 10, as well as other operations described herein for performing ML model generalization and specification may be implemented by one or means-plus-function components. For example, in some cases, such operations may be implemented by means for ML model generalization and specification.

### EXAMPLE CLAUSES

Implementation examples are described in the following numbered clauses:
Clause 1: A method for wireless communications at a user equipment (UE), comprising: storing at least a first type of generalization characteristics supported by a first machine learning (ML) model; and determining applicability of the first ML model to a cell, based on the first type of generalization characteristics supported by the first ML model and deployment characteristics of the cell.
Clause 2: The method of Clause 1, further comprising receiving, from a network entity of the cell, an indication of the deployment characteristics.
Clause 3: The method of any one of Clauses 1-2, wherein: the at least a first type of generalization characteristics comprises different types of generalization characteristics supported by different ML models including the first ML model. For example, the at least a first type of generalization characteristics may comprise a plurality of types of generalization characteristics, wherein each type of generalization characteristics is supported by at least one of a plurality of ML models, the plurality of ML models including the first ML model.
Clause 4: The method of Clause 3, wherein at least one of the different types of generalization characteristics (or plurality of types of generalization characteristics) has one or more subtypes.
Clause 5: The method of Clause 4, wherein: each of the one or more subtypes is defined by one or more categories of generalization characteristics, and the one or more categories are based on at least one of base station location information, range of cell, propagation characteristics, an antenna configuration, or a combination of parameters indicated by a network entity.
Clause 6: The method of Clause 4 or Clause 5, further comprising indicating that at least one of the different ML models is applicable to one or more cells deployed in accordance with the one or more subtypes.
Clause 7: The method of any of Clauses 3 to 6, wherein: different ML models are applicable to cell specific models or to a group of cells with similar deployment characteristics.
Clause 8: The method of Clause 7, wherein: at least one ML model type is applicable to at least one of: a specific cell indicated by global cell ID; a group of cells indicated by a list of cell IDs, a RAN notification area ID, paging area ID, or an ID for ML model cell groups; or all cells or a subset of cells with a same network ID.
Clause 9: The method of any of Clauses 3 to 8, wherein: the different types of generalization characteristics comprise at least one of: a delay spread range, a path loss range, a UE speed range, multiple sectors in a cell, or an area map in a cell.
Clause 10: The method of any of Clauses 3 to 9, wherein the different ML models support a range of reference signal (RS) configuration IDs.
Clause 11: The method of any one of Clauses 1-10, further comprising providing a generalization description of the first ML model to a network entity.
Clause 12: The method of any one of Clauses 1-11, further comprising receiving, from a network entity, an indication of the first type of generalization characteristics supported by the first ML model.
Clause 13: The method of Clause 12, wherein the indication of the first type of generalization characteristics supported by the first ML model is received via at least one of broadcast signaling or groupcast signaling.
Clause 14: The method of Clause 12, further comprising transmitting signaling acknowledging receipt of the indication of the first type of generalization characteristics supported by the first ML model.
Clause 15: The method of any one of Clauses 1-14, wherein the UE stores at least a second type of generalization characteristics supported by the first ML model.
Clause 16: The method of any one of Clauses 1-15, further comprising reporting an out-of-model coverage to a network entity, when data to be input to the first ML model is outside the first type of generalization characteristics supported by the first ML model; and performing one or more actions in response to detecting the out-of-model coverage.
Clause 17: The method of Clause 16, wherein the one or more actions comprise at least one of: requesting the network entity to deactivate the first ML model; requesting a switch from the first ML model to a second ML model by indicating current observed channel characteristics; using a best matched ML model type with reduced performance; or switching on a data collection function.
Clause 18: A method for wireless communications at a network entity, comprising: determining deployment characteristics of a cell served by the network entity; and receiving an indication that at least a first machine learning (ML) model, deployed at a user equipment (UE), is applicable to the cell, based on at least a first type of generalization characteristics supported by the first ML model and the deployment characteristics.
Clause 19: The method of Clause 18, further comprising transmitting an indication of the deployment characteristics.
Clause 20: The method of any one of Clauses 18-19, wherein: the at least a first type of generalization characteristics comprises different types of generalization characteristics supported by different ML models including the first ML model.
Clause 21: The method of Clause 20, wherein at least one of the different types of generalization characteristics has one or more subtypes.
Clause 22: The method of Clause 21, wherein: each of the one or more subtypes is defined by one or more categories of generalization characteristics, and the one or more categories are based on at least one of base station location information, range of cell, propagation characteristics, an antenna configuration, or a combination of parameters indicated by the network entity.
Clause 23: The method of Clause 20 or Clause 21, wherein: different ML models are applicable to cell specific models or to a group of cells with similar deployment characteristics.
Clause 24: The method of any one of Clauses 18-23, further comprising receiving signaling registering the first type of generalization characteristics supported by the first ML model with the network entity.
Clause 25: The method of any one of Clauses 18-24, further comprising transmitting an indication of a type of generalization characteristics supported by the first ML model.
Clause 26: The method of Clause 25, wherein the indication of the type of generalization characteristics supported by the first ML model is transmitted via at least one of broadcast signaling or groupcast signaling.
Clause 27: The method of Clause 25 or Clause 26, further comprising receiving signaling acknowledging receipt, by the UE, of the indication of the type of generalization characteristics supported by the first ML model.
Clause 28: The method of any of Clauses 18 to 27, further comprising: receiving a reporting of out-of-model coverage detected by the UE, indicating that data to be input to the first ML model is outside the type of generalization characteristics supported by the first ML model; and receiving, with or after receiving the reporting of out-of-model coverage, at least one of a request to deactivate the first ML model or a request for an ML model type switch.
Clause 29: The method of any one of Clauses 1-16, wherein the first ML model is deployed at the UE.
Clause 30: An apparatus, comprising: a memory comprising executable instructions; and a processor configured to execute the executable instructions and cause the apparatus to perform a method in accordance with any one of Clauses 1-29.
Clause 31: An apparatus, comprising means for performing a method in accordance with any one of Clauses 1-29.
Clause 32: A non-transitory computer-readable medium comprising executable instructions that, when executed by a processor of an apparatus, cause the apparatus to perform a method in accordance with any one of Clauses 1-29.
Clause 33: A computer program product embodied on a computer-readable storage medium comprising code for performing a method in accordance with any one of Clauses 1-29.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications by a user equipment (UE), comprising:
a memory comprising executable instructions, and one or more processors configured to execute the executable instructions and cause the UE to:
store at least a first type of generalization characteristics supported by a first machine learning (ML) model; and
determine applicability of the first ML model to a cell, based on the first type of generalization characteristics supported by the first ML model and deployment characteristics of the cell.

2. The apparatus of claim 1, wherein the one or more processors are further configured to execute the executable instructions and cause the UE to receive, from a network entity of the cell, an indication of the deployment characteristics.

3. The apparatus of claim 1, wherein:
the at least a first type of generalization characteristics comprises different types of generalization characteristics supported by different ML models including the first ML model.

4. The apparatus of claim 3, wherein at least one of the different types of generalization characteristics has one or more subtypes.

5. The apparatus of claim 4, wherein:
each of the one or more subtypes is defined by one or more categories of generalization characteristics, and
the one or more categories are based on at least one of base station location information, range of cell, propagation characteristics, an antenna configuration, or a combination of parameters indicated by a network entity.

6. The apparatus of claim 4, wherein the one or more processors are further configured to execute the executable instructions and cause the UE to indicate that at least one of the different ML models is applicable to one or more cells deployed in accordance with the one or more subtypes.

7. The apparatus of claim 3, wherein:
different ML models are applicable to a group of cells with similar deployment characteristics.

8. The apparatus of claim 7, wherein:
at least one ML model type is applicable to at least one of:
a specific cell indicated by global cell ID;
a group of cells indicated by a list of cell IDs, a RAN notification area ID, paging area ID, or an ID for ML model cell groups; or
all cells or a subset of cells with a same network ID.

9. The apparatus of claim 3, wherein:
the different types of generalization characteristics comprise at least one of: a delay spread range, a path loss range, a UE speed range, multiple sectors in a cell, or an area map in a cell.

10. The apparatus of claim 3, wherein the different ML models support a range of reference signal (RS) configuration IDs.

11. The apparatus of claim 1, wherein the one or more processors are further configured to execute the executable instructions and cause the UE to provide a generalization description of the first ML model to a network entity.

12. The apparatus of claim 1, wherein the one or more processors are further configured to execute the executable instructions and cause the UE to receive, from a network entity, an indication of the first type of generalization characteristics supported by the first ML model.

13. The apparatus of claim 12, wherein the indication of the first type of generalization characteristics supported by the first ML model is received via at least one of broadcast signaling or groupcast signaling.

14. The apparatus of claim 12, wherein the one or more processors are further configured to execute the executable instructions and cause the UE to transmit signaling acknowledging receipt of the indication of the first type of generalization characteristics supported by the first ML model.

15. The apparatus of claim 1, wherein the deployment characteristics of the cell comprise at least one of: a site of deployment or one or more characteristics of a site of deployment.

16. The apparatus of claim 1, wherein the one or more processors are further configured to execute the executable instructions and cause the UE to:
report an out-of-model coverage to a network entity, when data to be input to the first ML model is outside the first type of generalization characteristics supported by the first ML model; and
perform one or more actions in response to detecting the out-of-model coverage.

17. The apparatus of claim 16, wherein the one or more actions comprise at least one of:
requesting the network entity to deactivate the first ML model;
requesting a switch from the first ML model to a second ML model by indicating current observed channel characteristics;
using a best matched ML model type with reduced performance; or
switching on a data collection function.

18. An apparatus for wireless communications by a network entity, comprising:
a memory comprising executable instructions, and
one or more processors configured to execute the executable instructions and cause the network entity to:
determine deployment characteristics of a cell served by the network entity; and
receive an indication that at least a first machine learning (ML) model, deployed at a user equipment (UE), is applicable to the cell, based on at least a first type of generalization characteristics supported by the first ML model and the deployment characteristics.

19. The apparatus of claim 18, wherein the one or more processors are further configured to execute the executable instructions and cause the network entity to transmit an indication of the deployment characteristics.

20. The apparatus of claim 18, wherein:
the at least a first type of generalization characteristics comprises different types of generalization characteristics supported by different ML models including the first ML model.

21. The apparatus of claim 20, wherein at least one of the different types of generalization characteristics has one or more subtypes.

22. The apparatus of claim 21, wherein:
each of the one or more subtypes is defined by one or more categories of generalization characteristics, and
the one or more categories are based on at least one of base station location information, range of cell, propagation characteristics, an antenna configuration, or a combination of parameters indicated by the network entity.

23. The apparatus of claim 20, wherein:
different ML models are applicable to a group of cells with similar deployment characteristics.

24. The apparatus of claim 18, wherein the one or more processors are further configured to execute the executable instructions and cause the network entity to receive signaling registering the first type of generalization characteristics supported by the first ML model with the network entity.

25. The apparatus of claim 18, wherein the one or more processors are further configured to execute the executable instructions and cause the network entity to transmit an indication of the first type of generalization characteristics supported by the first ML model.

26. The apparatus of claim 25, wherein the indication of the first type of generalization characteristics supported by the first ML model is transmitted via at least one of broadcast signaling or groupcast signaling.

27. The apparatus of claim 25, wherein the one or more processors are further configured to execute the executable instructions and cause the network entity to receive signaling acknowledging receipt, by the UE, of the indication of the first type of generalization characteristics supported by the first ML model.

28. The apparatus of claim 18, wherein the one or more processors are further configured to execute the executable instructions and cause the network entity to:
receive a reporting of out-of-model coverage detected by the UE, indicating that data to be input to the first ML model is outside the first type of generalization characteristics supported by the first ML model; and
receive, with or after receiving the reporting of out-of-model coverage, at least one of a request to deactivate the first ML model or a request for an ML model type switch.

29. A method for wireless communications at a user equipment (UE), comprising:
storing at least a first type of generalization characteristics supported by a first machine learning (ML) model; and
determining applicability of the first ML model to a cell, based on the first type of generalization characteristics supported by the first ML model and deployment characteristics of the cell.

30. A method for wireless communications at a network entity, comprising:
determining deployment characteristics of a cell served by the network entity; and
receiving an indication that at least a first machine learning (ML) model, deployed at a user equipment (UE), is applicable to the cell, based on at least a first type of generalization characteristics supported by the first ML model and the deployment characteristics.
